(19) United States
(12) Patent Application Publication
(10) Pub. No.: US 2006/0035663 A1
(43) Pub. Date: Feb. 16, 2006

(54) Mobile telephone system with media processor

(76) Inventor: Nai-Sheng Cheng, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/914,211

(22) Filed: Aug. 10, 2004

(51) Int. Cl. H04M 1/00

(52) U.S. Cl. 455/550.1

(57) ABSTRACT

A mobile phone system with multimedia processor comprising a radio frequency (RF) receiver/transmitter module, an analog base band (ABB) module, a digital base band module (DBB), a multimedia processor module, a flash memory module, a static random access memory module, a display module, a removable memory module, a high-speed bi-directional interface, a keypad, a microphone, and a speaker. The multimedia processor module performs certain digital signal processing on multimedia data. The multimedia processor module provides the telephone with improved multimedia capabilities and increased performance.

### BACKGROUND OF THE INVENTION

1. Field of the Invention

The present invention relates to mobile telephone system. More specifically, the present invention discloses a mobile telephone system with media processor that improves multimedia performance for the mobile phone.

2. Description of the Prior Art

Mobile telephones continue to evolve and provide users with more and more features. As the number of functions increases, the mobile telephone becomes taxed to the extent of its capabilities.

Additionally, users are accustomed to accessing multimedia on computers and are demanding similar operation on their mobile telephones. Unfortunately, conventional telephones are not adequately equipped to handle these tasks.

Therefore, there is need for an improved mobile telephone system and architecture featuring a multimedia processor that expands the multimedia capabilities and improves the performance of the mobile telephone.

### SUMMARY OF THE INVENTION

To achieve these and other advantages and in order to overcome the disadvantages of the conventional method in accordance with the purpose of the invention as embodied and broadly described herein, the present invention provides mobile telephone system with multimedia processor performing digital signal processing on data thereby allowing the telephone to utilize multimedia more effectively and efficiently.

The mobile phone system with multimedia processor comprising a radio frequency (RF) receiver/transmitter module, an analog base band (ABB) module, a digital base band module (DBB), a multimedia processor module, an image sensor, a flash memory module, a static random access memory module, a display module, a removable memory module, a high-speed bi-directional interface, a keypad, a microphone, and a speaker.

The multimedia processor provides accelerated graphics and video in order to provide superior multimedia performance and quality. The multimedia processor also adds high quality audio and video capabilities to the mobile phone. Users can record and view video, take photographs, listen to and record music, and take part in mobile video conferencing.

In addition the multimedia processor is responsible for interfacing with the keypad, display module, image sensor, and storage components such as flash memory, random access memory, and removable memory.

Furthermore, the application program and main machine interface (MMI) are included in the multimedia processor module thereby providing improved performance and smoother operation of the phone.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a block diagram illustrating a mobile phone system architecture according to an embodiment of the present invention;

FIG. 2 is a block diagram illustrating a mobile phone system architecture with multimedia processor according to an embodiment of the present invention;

FIG. 3 is a block diagram illustrating a mobile phone system architecture with multimedia processor according to an embodiment of the present invention;

FIG. 4 is a block diagram illustrating a mobile phone system architecture with multimedia processor according to an embodiment of the present invention;

FIG. 5 is a block diagram illustrating a mobile phone system architecture with multimedia processor according to an embodiment of the present invention;

FIG. 6 is a block diagram illustrating a mobile phone system architecture with multimedia processor according to an embodiment of the present invention; and

FIG. 7 is a block diagram illustrating a mobile phone system architecture with multimedia processor according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

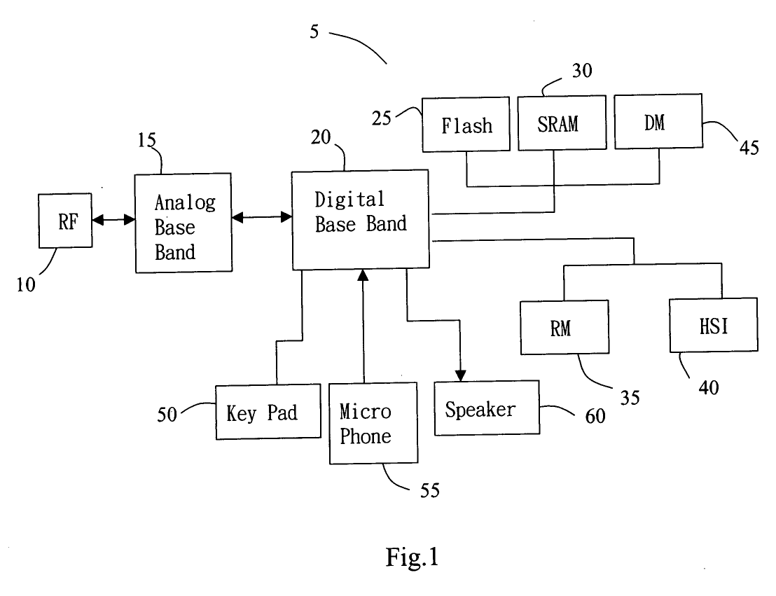

Refer to FIG. 1, which is a block diagram illustrating a mobile phone system architecture according to an embodiment of the present invention.

As shown in FIG. 1, the mobile phone system 5 of the present invention comprises a radio frequency (RF) receiver/transmitter module 10, an analog base band (ABB) module 15, a digital base band module (DBB) 20, a flash memory module 25, a static random access memory module 30, a display module 45, a removable memory module 35, a high-speed bi-directional interface 40, a keypad 50, a microphone 55, and a speaker 60.

The RF module 10 receives and transmits wireless telephone signals from and to other handsets. The ABB module 15 performs the required or necessary signal processing on the signal in the transmit and receive signal paths. For example, during receiving the RF module 10 will receive the signal and pass it to the ABB module 15. The signal processing that the ABB module 15 may perform is, for example, amplification and filtering of the signal.

The DBB module 20 also performs signal processing on the signal in the transmit and receive signal paths. However, while the ABB module 15 typically works with the signal in the analog domain, the DBB module 20 works with the signal mostly in the digital domain.

In order to permit the ABB 15 and DBB 20 modules to cooperate, either one or both of these modules comprises an analog to digital (A/D) converter and a digital to analog (D/A) converter. While receiving, the received signal is analog and must be converted to digital so that the DBB module 20 can utilize the signal. While transmitting the digital signal must be converted into analog in order for the ABB module 15 to be able to use it. Typically, the A/D and D/A conversion is carried out by the DBB module 20, however, either one or both of these can also be carried out by converters in the ABB module 15. Furthermore, the ABB 15 and DBB 20 modules can be combined into one integrated circuit chip for convenience and form a single ABB/DBB module.

The DBB module 20 further comprises a main machine interface (MMI) for interfacing and communicating with the remainder of the telephone system. Typically, the MMI is realized in software but can also by a hybrid of hardware, software, or firmware.

A keypad 50, microphone 55, and a speaker 60 interface with the DBB module 20. The keypad 50 allows a user to input commands, data, etc. into the telephone system 5. The microphone 55 allows external audio data to be input into the telephone 5. The speaker 60 allows audio data to be output from the telephone 5.

The flash memory module 25 and the SRAM module 30 allow data to be stored inside the telephone 5. This data can be stored and recalled as required or needed. The flash memory module 25 is a non-volatile memory allowing the data to be stored without being lost when power is turned off. The SRAM module 30 is a volatile memory, however it can also be powered by the battery so as to retain data during power off. Since the SRAM module 30 typically requires or uses less power than the flash memory 25, the SRAM module 30 is usually used for and by applications. The flash memory module 25 is usually used for more conventional non-volatile data storage. Additionally, the flash memory module 25 and the SRAM module 30 can be integrated into a single chip package if desired.

The display module 45, for example a liquid crystal display (LCD), is for displaying data, status, or other information on a screen for the user.

The removable memory module 35 allows data to be stored similar to the flash memory module 25, however, data stored in the removable memory module 35 can be removed from the telephone by removing the removable memory module 35. The removable memory module 35 is, for example, a compact flash (CF), a memory stick, a microdrive, a multimedia card (MMC), a secure digital (SD), smart media (SM), or other type of removable memory card. This allows data to be easily transported between electronic devices and used by other devices.

The high-speed bi-directional interface 40 is, for example, a universal serial bus (USB), IEEE 1394, Firewire, Bluetooth, infrared, or other interface. This allows the telephone to interface with other electronic devices. For example, the telephone can be connected to a computer via the high-speed bi-directional interface 40 and download or upload data to/from the computer.

Additionally, a flash drive or other type of external memory can be connected to the high-speed interface 40 and can be used as external or removable storage.

Several buses allow the DBB module 20 to interface with the flash memory module 25, static random access memory module 30, display module 45, removable memory module 35, and high-speed bi-directional interface 40. A parallel address and parallel data bus connect the flash memory module 25, static random access memory module 30, removable memory module 35, and high-speed bi-directional interface 40 with the DBB module 20. A parallel data bus connects the display module 45 with the DBB module 20.

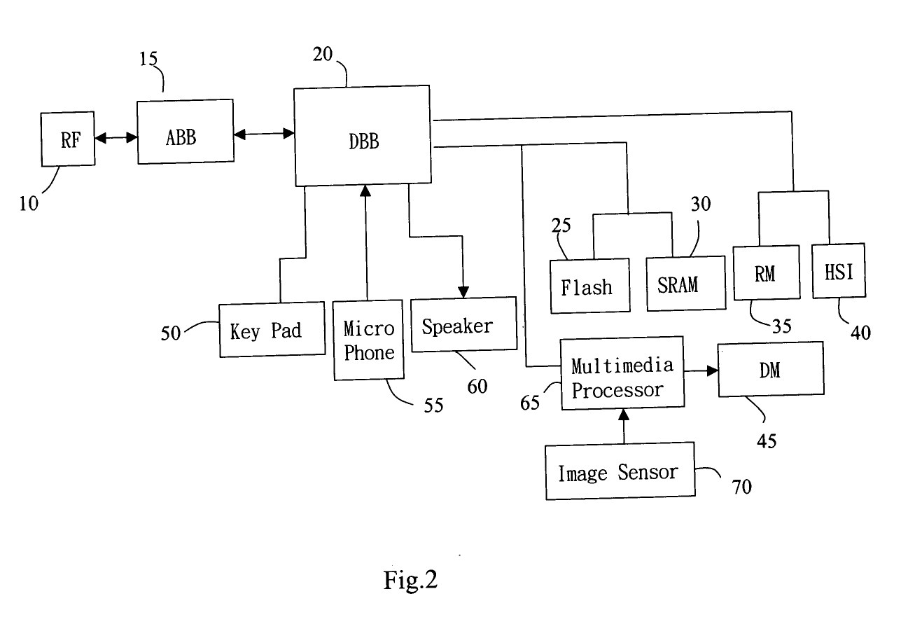

Refer to FIG. 2, which is a block diagram illustrating a mobile phone system architecture with multimedia processor according to an embodiment of the present invention.

In this embodiment, the RF module 10, ABB module 15, keypad 50, microphone 55, speaker 60, flash memory module 25, SRAM module 30, removable memory module 35, and high-speed bi-directional interface 40 operate in a similar manner as with the embodiment illustrated in FIG. 1.

However, in this embodiment the telephone system 5 further comprises a multimedia processor module 65 and an image sensor 70. The image sensor 70 is, for example, a charge-coupled device (CCD) sensor, a complementary metal oxide semiconductor (CMOS) sensor, hybrid imaging technology (HIT) sensor, a silicon on insulator (SOI) sensor, or other type of image sensor. The image sensor 70 allows visual data such as a photograph or movie to be captured by the telephone. The image data collected by the image sensor 70 is input into the multimedia processor module 65 for processing.

The multimedia processor module 65 performs certain digital signal processing on the data that is sent to the display module 45. Whereas in the embodiment illustrated in FIG. 1 where the data bus connected the DBB module 20 and the display module 45, in this embodiment the data bus connects the DBB module 20 and the multimedia processor module 65 and the multimedia processor module 65 connects to the display module 45.

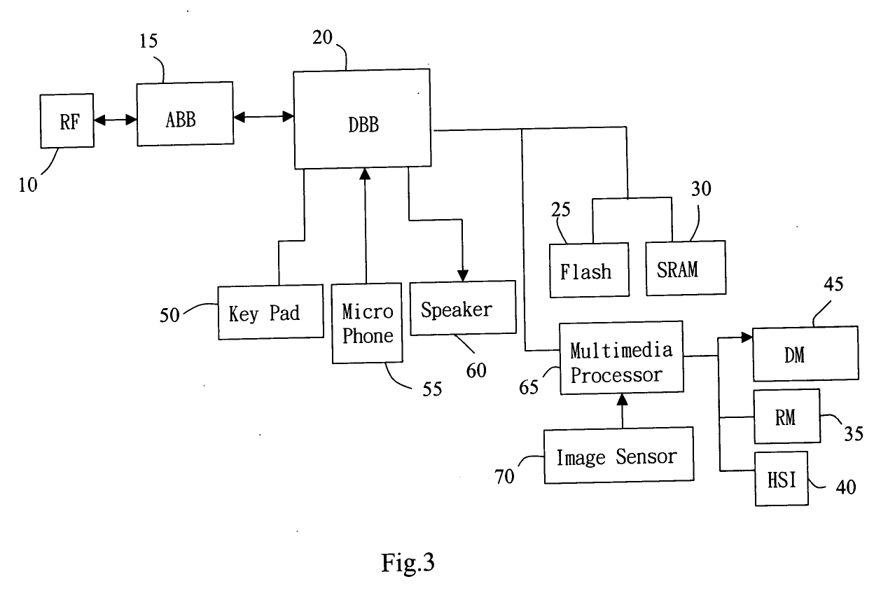

Refer to FIG. 3, which is a block diagram illustrating a mobile phone system architecture with multimedia processor according to an embodiment of the present invention.

As shown in FIG. 3, the telephone system operates in a manner similar to the embodiment of FIG. 2. However, in this embodiment, the removable memory module 35 and the high-speed bi-directional interface 40 connect with the multimedia processor 65 instead of the DBB module 20. This allows image data to be more effective utilized by the telephone and the removable memory module 35 and the high-speed bidirectional interface 40, via the multimedia processor 65.

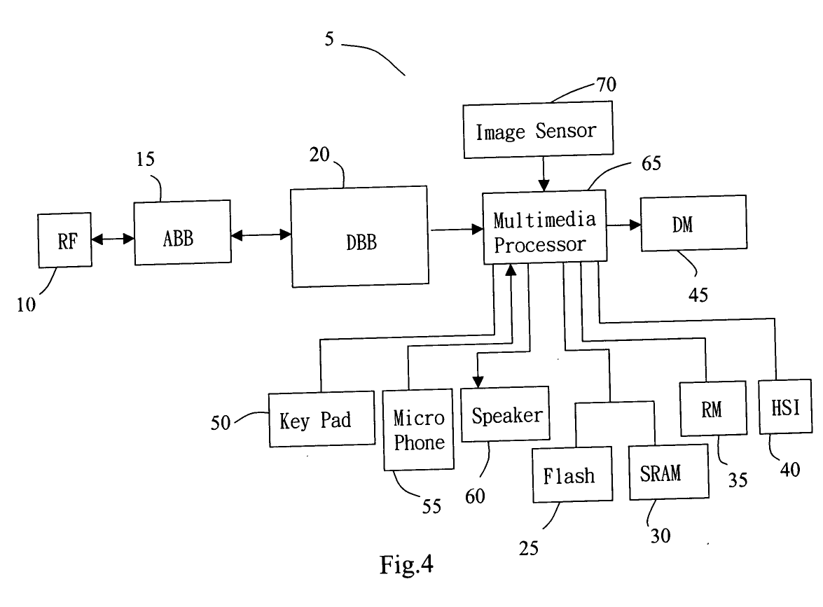

Refer to FIG. 4, which is a block diagram illustrating a mobile phone system architecture with multimedia processor according to an embodiment of the present invention.

In this embodiment the keypad 50, microphone 55, speaker 60, flash memory module 25, SRAM module 30, removable memory module 35, and high-speed bi-directional interface 40 connect with the multimedia processor module 65. Also, the multimedia processor module 65 in this embodiment further comprises embedded MMI software.

To allow the DBB 20 to interface with the flash memory module 25 or the SRAM module 30, a slight time delay should be included since the DBB 20 is unaware that the flash memory module 25 and SRAM module 30 are blocked by another chip.

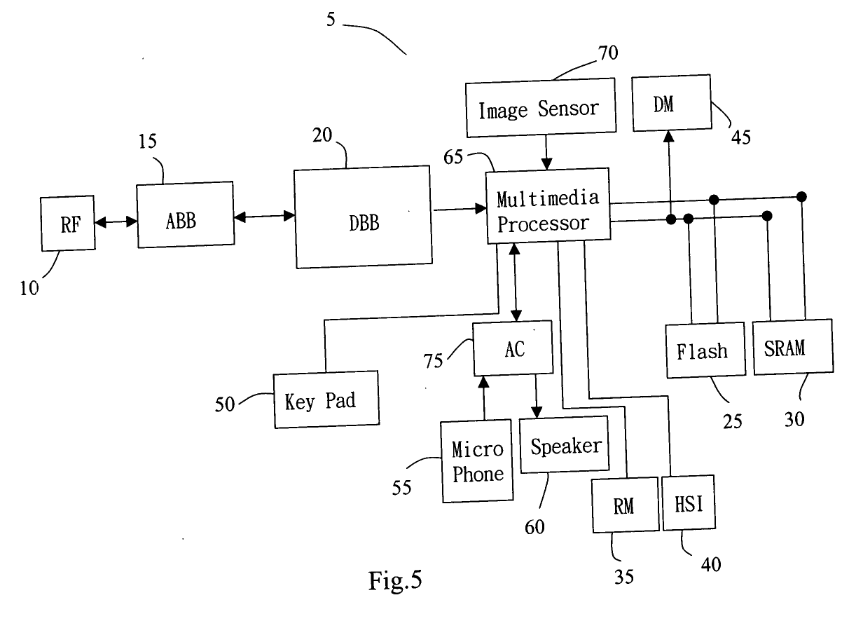

Refer to FIG. 5, which is a block diagram illustrating a mobile phone system architecture with multimedia processor according to an embodiment of the present invention.

As shown in FIG. 5, an audio codec module 75 interfaces the microphone 55 and speaker 60 with the multimedia processor module 65. The audio codec module 75 performs the A/D and D/A conversions for the multimedia processor module 65, thus improving the utilization of audio data by the telephone system.

Additionally, a parallel address and data bus are shared by the flash memory module 25 and the SRAM module 30. The data bus is also shared by the display module 45.

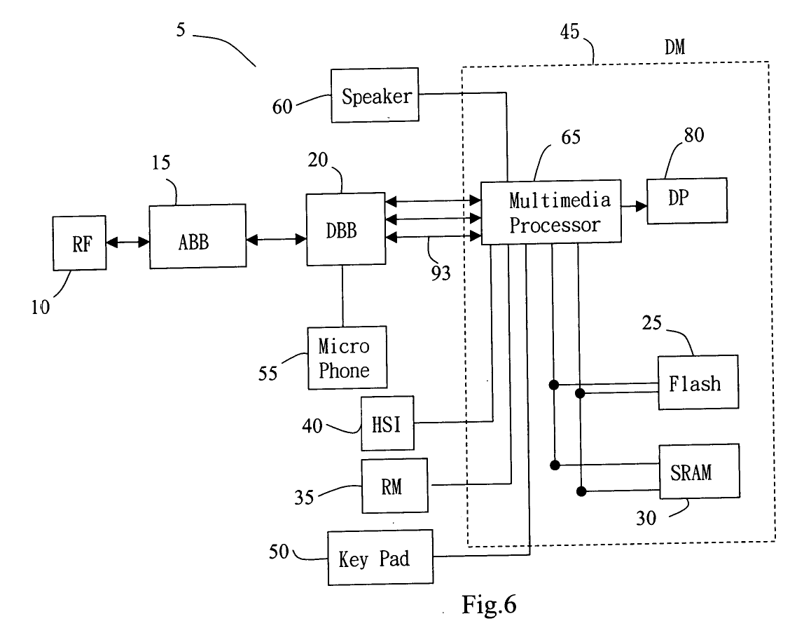

Refer to FIG. 6, which is a block diagram illustrating a mobile phone system architecture with multimedia processor according to an embodiment of the present invention.

In this embodiment the microphone 55 is connected to the DBB module 20. The DBB module 20 then converts the analog audio into digital format or converts the digital audio into analog format.

As shown in FIG. 6, the display module 45 comprises the multimedia processor module 65 with embedded MMI software, display driver, and embedded memory. The display module 45 further comprises a display panel 80, for example an LCD panel, a flash memory module 25, and an SRAM module 30.

The high-speed bi-directional interface 40, removable memory module 35, keypad 50, and speaker 60 interface with the multimedia processor module 65 in the display module 45. A bi-directional serial bus 93 interfaces the DBB module 20 and the multimedia processor module 65. This serial bus 93 allows the digital audio signal to be passed between the DBB module 20 and the multimedia processor module 65.

Additionally, a bi-directional parallel address and data bus interface the DBB module 20 and the multimedia processor module 65. Alternatively, only a parallel data bus is used.

In the display module 45, the multimedia processor module 65 utilizes a shared parallel address and data bus to interface with the flash memory module 25 and SRAM module 30. The multimedia processor module 65 also provides image data to a display panel 80.

An advantage to the embodiment illustrated in FIG. 6 is that the parallel address and data bus and the serial bus between the DBB module 20 and the multimedia processor module 65 and the interfaces between the high-speed bi-directional interface 40, the removable memory module 35, the keypad 50, and the multimedia processor module 65 can be achieved by utilizing a flexible print circuit (FPC).

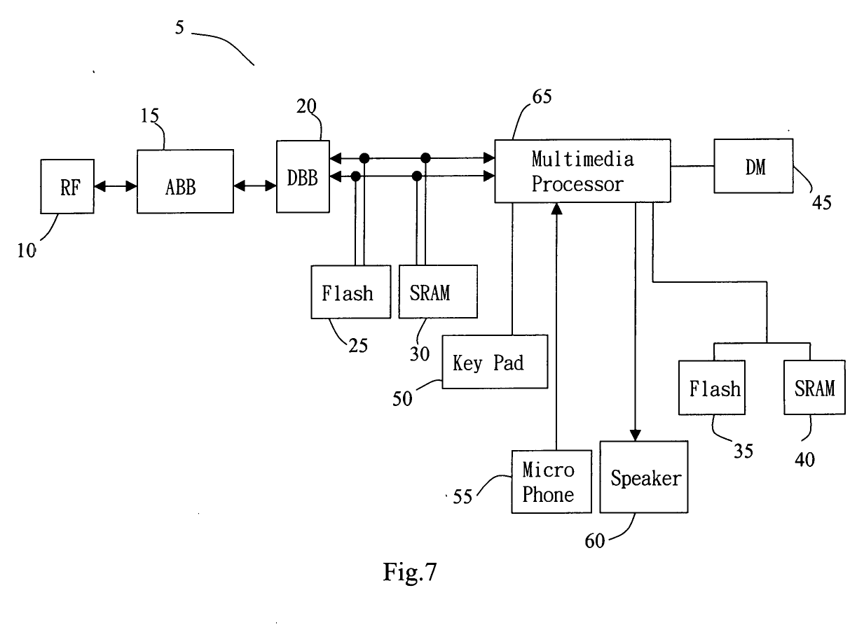

Refer to FIG. 7, which is a block diagram illustrating a mobile phone system architecture with multimedia processor according to an embodiment of the present invention.

In this embodiment the flash memory module 25 and the SRAM module 30 share the parallel address and parallel data bus between the DBB module 20 and the multimedia processor module 65 with embedded MMI software. The other interfaces interface with the multimedia processor module 65.

Therefore, the present invention provides an improved mobile telephone system and architecture featuring a multimedia processor that expands the multimedia capabilities and improves the performance of the mobile telephone.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A mobile phone system comprising:
a multimedia processor module for processing multimedia data;
a digital base band module electrically connected to the multimedia processor module for performing digital signal processing;
a display module electrically connected to the multimedia processor module for displaying image data;
a keypad electrically connected to the multimedia processor module for inputting data; and
an image sensor electrically connected to the multimedia processor module for inputting image data.

2. The mobile phone system of claim 1, further comprising a removable memory module electrically connected to the multimedia processor module for storing data.

3. The mobile phone system of claim 1, further comprising a high-speed bi-directional interface electrically connected to the multimedia processor module for interfacing with external devices.

4. The mobile phone system of claim 1, further comprising: a radio frequency receiver/transmitter module for receiving and transmitting wireless telephone signals;
an analog base band module electrically connected to the radio frequency receiver/transmitter module and the digital base band module for performing analog signal processing;
a flash memory module electrically connected to the multimedia processor module for storing data;
a static random access memory module electrically connected to the multimedia processor module for storing temporary data;
a microphone electrically connected to the multimedia processor module for inputting audio data; and
a speaker electrically connected to the multimedia processor module for outputting audio data.

5. The mobile telephone system of claim 1, the display module comprising a liquid crystal display.

6. The mobile telephone system of claim 2, the removable memory module comprising a compact flash card, a memory stick, a microdrive, a multimedia card, a secure digital card, a smart media card, or a removable memory card.

7. The mobile telephone system of claim 3, the high-speed bi-directional interface comprising a Universal Serial Bus, IEE 1394, Firewire, Bluetooth, or infrared interface.

8. The mobile telephone system of claim 1, the image sensor comprising a charge-coupled device sensor, a complementary metal oxide semiconductor sensor, a hybrid imaging technology sensor, or a silicon on insulator sensor.

9. The mobile telephone system of claim 1, wherein the digital base band module and the multimedia processor module are connected by a parallel address bus and a parallel data bus.

10. The mobile telephone system of claim 4, wherein the flash memory module and the static random access memory module share a parallel address bus and a parallel data bus with the digital base band module and the multimedia processor module.

11. The mobile telephone system of claim 1, further comprising a serial bus for digital audio connecting the digital base band module and the multimedia processor module.

12. The mobile telephone system of claim 4, further comprising an audio codec module between the multimedia processor module and the microphone and speaker.

13. The mobile telephone system of claim 1, the multimedia processor module further comprising embedded main machine interface software.

14. A mobile phone system comprising:
a multimedia processor module for processing multimedia data;
a digital base band module electrically connected to the multimedia processor module for performing digital signal processing;
a display module electrically connected to the multimedia processor module for displaying image data; and
a keypad electrically connected to the multimedia processor module for inputting data.

15. The mobile telephone system of claim 14, further comprising:
a radio frequency receiver/transmitter module for receiving and transmitting wireless telephone signals;
an analog base band module electrically connected to the radio frequency receiver/transmitter module and the digital base band module for performing analog signal processing;
a flash memory module electrically connected to the multimedia processor module for storing data;
a static random access memory module electrically connected to the multimedia processor module for storing temporary data;
a removable memory module electrically connected to the multimedia processor module for storing data;
a high-speed bi-direction interface electrically connected to the multimedia processor module for interfacing with external devices;
an image sensor connected to the multimedia processor module for inputting image data;
a microphone electrically connected to the multimedia processor module for inputting audio data; and
a speaker electrically connected to the multimedia processor module for outputting audio data.

16. The mobile telephone system of claim 15, the removable memory module comprising a compact flash card, a memory stick, a microdrive, a multimedia card, a secure digital card, a smart media card, or a removable memory card.

17. The mobile telephone system of claim 15, the high-speed bidirectional interface comprising a Universal Serial Bus, IEE 1394, Firewire, Bluetooth, or infrared interface.

18. The mobile telephone system of claim 15, the image sensor comprising a charge-coupled device sensor, a complementary metal oxide semiconductor sensor, a hybrid imaging technology sensor, or a silicon on insulator sensor.

19. The mobile telephone system of claim 14, wherein the digital base band module and the multimedia processor module are connected by a parallel address bus and a parallel data bus.

20. The mobile telephone system of claim 15, wherein the flash memory module and the static random access memory module share a parallel address bus and a parallel data bus with the digital base band module and the multimedia processor module.

21. The mobile telephone system of claim 14, further comprising a serial bus for digital audio connecting the digital base band module and the multimedia processor module.

22. The mobile telephone system of claim 15, further comprising an audio codec module between the multimedia processor module and the microphone and speaker.

23. The mobile telephone system of claim 14, the multimedia processor module further comprising embedded main machine interface software.
